(19) United States
(12) Patent Application Publication
(10) Pub. No.: US 2010/0042467 A1
(43) Pub. Date: Feb. 18, 2010

(54) Method and Apparatus for Implementing an Automatic Marketing System

(76) Inventors: Reza Bundy, Venice, CA (US); John Shiple, Los Angeles, CA (US); Mark Liu, Venice, CA (US)

Correspondence Address: DLA PIPER US LLP, 1999 AVENUE OF THE STARS, SUITE 400, LOS ANGELES, CA, 90067-6023, US

(21) Appl. No.: 12/191,981

(22) Filed: Aug. 14, 2008

(51) Int. Cl. G06Q 30/00

(52) U.S. Cl. 705/10; 705/26; 705/14.4

(57) ABSTRACT

The system provides a method and apparatus for automatically generating marketing and promotional information for an item for sale. The system tracks sales and offers for sale of similar items and determines the words, images, and descriptions that have been most useful in selling items in the past. The seller is presented with information about descriptions that can maximize price and/or minimize time on the market. The system operates by collecting data from prior sales including selling price, expected selling price, start date, end date, images of item, time of year, geographical region, and a dictionary of terms and phrases used in prior sales. These factors are analyzed and identified as helpful or hurtful in a number of categories, including selling price and/or time on the market.

### BACKGROUND OF THE SYSTEM

There have been a number of systems to allow peer to peer transaction of products and services. By peer to peer in this application we refer to non-commercial sales between individuals. One example of a peer to peer transaction is the purchase or sale of an automobile between an owner of the automobile and an individual. In the past this has involved the placing of classified advertisements in some media such as a newspaper, a used vehicle focused publication, or on the internet. Some transactions are implemented via auction sites such as eBay.

A seller often chooses a peer-to-peer sale in the belief that the seller will be able to sell for a higher price than selling to a commercial buyer. This is often true for vehicles where the private sale price is considered to be higher than the trade-in value of the vehicle at a commercial car dealership. However, the ability to actually receive the higher private sale price is hampered by the lack of marketing ability of the seller. Due to poor marketing, the seller can artificially limit or reduce the pool of buyers for the seller's item. Applying well known economic principals of supply and demand, the lower the demand (the fewer interested buyers), the lower the selling price.

In addition, poor marketing can limit the appeal of the item even to the population of interested buyers. If important features of the item are not highlighted, a buyer may not recognize the value of the item in the same manner as the seller. This inability to cast a wide net and to properly inform potential buyers of important information about the item are factors in reducing optimum selling prices of items.

Another problem faced by sellers is time on the market. Often a seller does not want to dedicate extensive time to selling an item. A sale to a commercial buyer is typically accomplished in one or two days. A sale in a peer-to-peer system can take weeks and months. A seller may not be able to market the item in a way so as to minimize time on the market.

### SUMMARY OF THE SYSTEM

The system provides a method and apparatus for automatically generating marketing and promotional information for an item for sale. The system tracks sales and offers for sale of similar items and determines the words, images, and descriptions that have been most useful in selling items in the past. The seller is presented with information about descriptions that can maximize price and/or minimize time on the market. The system operates by collecting data from poor sales including selling price, expected selling price, start date, end date, images of item, time of year, geographical region, and a dictionary of terms and phrases used in prior sales. These factors arc analyzed and identified as helpful or hurtful in a number of categories, including selling price and/or time on the market.

### BRIEF DESCRIPTION OF THE DRAWINGS

FIG. 1 is a flow diagram illustrating marketing term data collection in an embodiment of the system.

FIG. 2 is a flow diagram illustrating the operation of the profile step of the system.

FIG. 3 is an embodiment of a vehicle information entry system.

FIG. 4 is an example of a query to the seller in an embodiment of the system.

FIG. 5 is an example of data entry in one embodiment of the system.

FIG. 6 is a flow diagram illustrating the text ranking step of an embodiment of the system.

FIG. 7 is a flow diagram illustrating inspection report translation.

FIG. 8 is an example of inspection report presentation.

FIG. 9 is a flow diagram illustrating auto evaluator content generation.

FIG. 10 illustrates auto evaluator content presentation.

FIG. 11 is an example hardware embodiment of the system.

FIG. 12 illustrates automatic marketing message presentation.

FIG. 13 is a flow diagram illustrating automatic marketing message generation.

FIG. 14 illustrates specification presentation.

### DETAILED DESCRIPTION OF THE SYSTEM

The system provides a method and apparatus for the implementation of an automatic marketing system. In the examples below, the system is described in connection with transactions involving automobiles. However, the system is not limited to such products and may be implemented with any goods and/or services without departing from the scope of the system.

The system collects data from prior sales of items and parses the text accompanying the advertisements or listing of the item. The system also collects data on start date of listing, end date of listing, price changes during listing, images used in marketing the item, and in what markets the item is marketed. In addition the system tracks the choice of sales channels in which the item is marketed (e.g. eBay, other on-line auction sites, classifieds, magazines, web portals, or other channels). In an auction channel, the system notes the starting auction price point to track how initial bid values can affect selling price and market time.

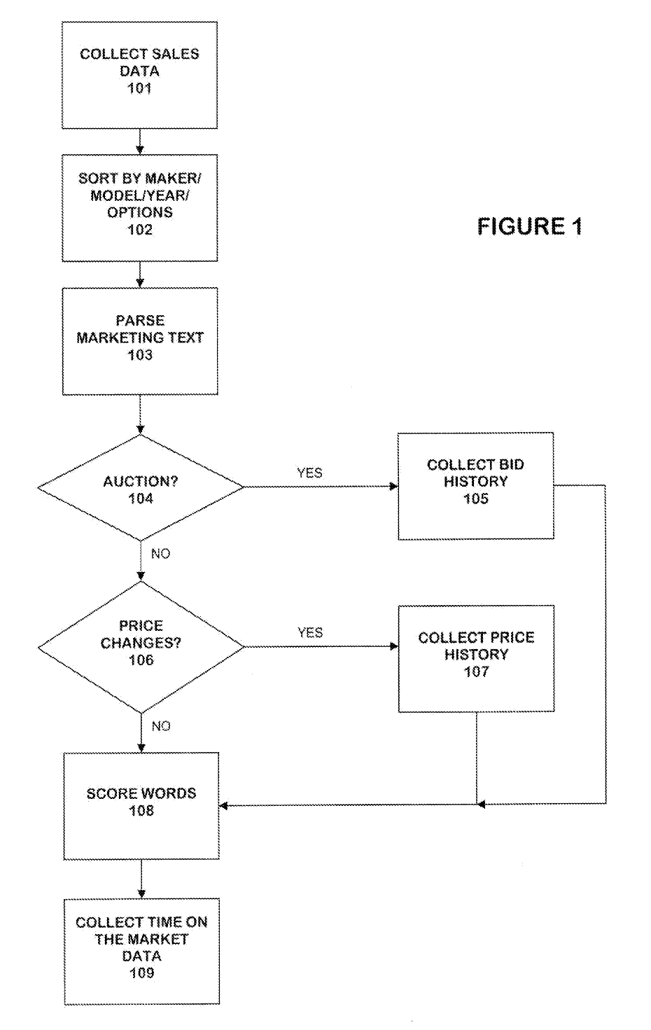

In one embodiment, the system tracks the sales data for vehicles. FIG. 1 is a flow diagram for the operation of the system in collecting relevant data that can be used to automate and optimize marketing. At step 101 sales data is collected from a number of sources. These sources can include a peer-to-peer site such as www.mota.net, (described in co-pending patent application Ser. No. ______ filed entitled ______ “Method and Apparatus for Peer-to-Peer Transactions” and assigned to the assignee of the present application and incorporated by reference herein in its entirety), eBay vehicle auctions, tracking classified advertisements, web portal sales (e.g. yahoo autos, recycler.com autotrader.com, etc.), and/or industry or trade data. At step 102 the data is sorted by make, model, model year, and options so that the use of the data can be optimized.

At step 103 any accompanying marketing text is parsed and each substantive word is stored in a database. A histogram of word usage may also be maintained as desired. At decision block 104 it is determined if the data comes from an auction. If so, the system collects the bid history at step 105. This includes tracking the starting bid price, number of bids, amount of increase in each bid, and of course, the final (winning) bid. If the data is not from an auction, the system checks at decision block 106 if there were price changes during the on sale period of the vehicle. If so, the system collects the price history. If not, and after steps 105 and 107, the system proceeds to step 108 and scores the harvested words from the data and ranks each word by its presence in a sale. This ranking is described in more detail below. The ranking is used to maximize the effectiveness of marketing for a particular vehicle. At step 109, the system collects the time on the market information from the data.

Vehicle Data Entry

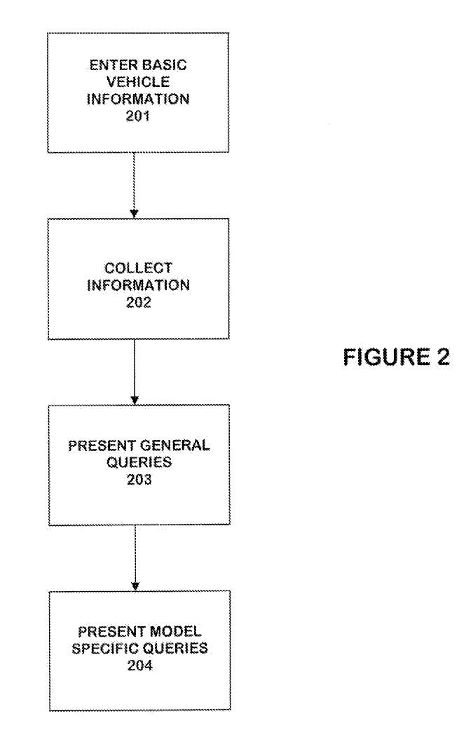

Before the marketing text can be generated, the system requires the seller to enter data into the system. This process is illustrated in FIGS. 2-5. FIG. 2 is a flow diagram illustrating the operation of the profile step of the system. At step 201 the seller enters basic information about the vehicle such as year, make, model and some other basic questions. This step collects information likely to be known by the seller that will assist in directing the seller in later steps of the process.

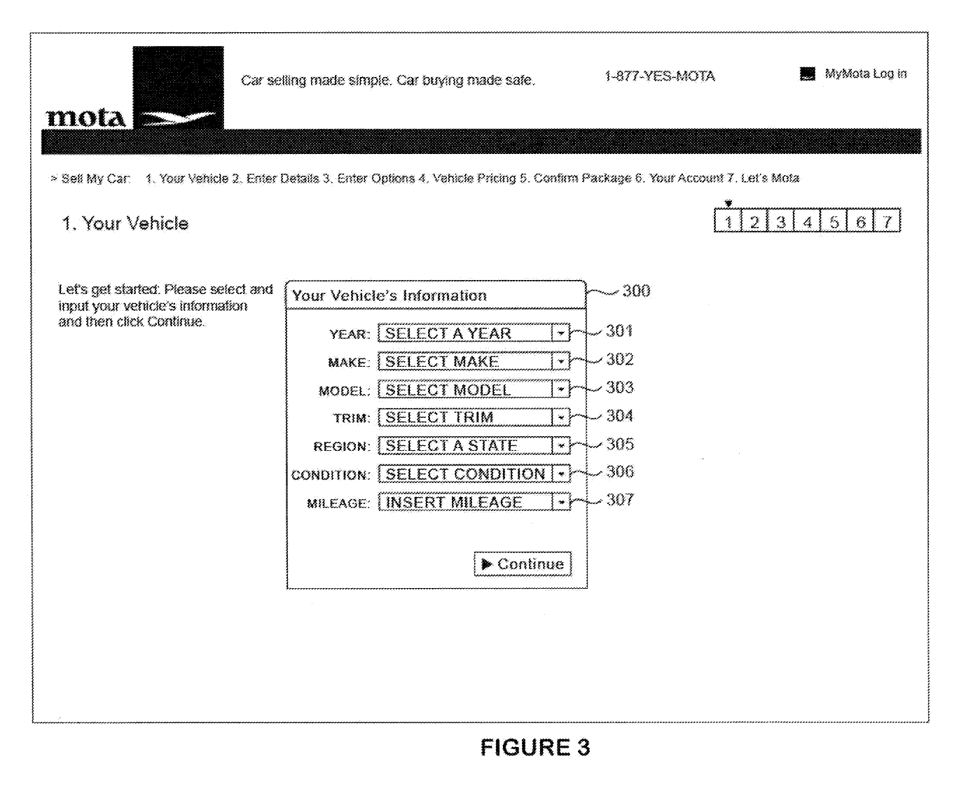

Referring briefly to FIG. 3, one embodiment of a vehicle information entry system 300 for implementing step 201 is illustrated. Here the seller chooses the year 301, make 302, and model 303 of the vehicle to be sold. In one embodiment, completion of the fields is done from top down, with each answer modifying lower fields so that appropriate choices are provided. For example, after the make 302 (e.g. Ford, Mercedes) is selected, the model menu 303 is populated only with models from that maker and made in the year selected at field 301. Similarly, the trim field 304 is populated only with options for that model of that year. The region (e.g. state) field 305 will affect later options presented to the seller as well (including some of the questions related to the biography of the vehicle as well as the price). The condition field 306 is often misunderstood by the seller but later questions that are customized for the vehicle aid in correctly describing the condition of the vehicle. Finally the seller enters the mileage 307 and proceeds to the next step.

Returning to FIG. 2, at step 202 the system collects the initial data entered by the seller in step 201 and retrieves a series of interactive queries for the seller that aid in providing more detail for the biography of the vehicle.

At step 203 the seller is presented with a series of general queries. In one embodiment, these questions are focused on the condition of the vehicle (interior, exterior, and mechanical), the everyday use of the vehicle, maintenance of the vehicle, extras, and a space for additional information that the seller may think is important.

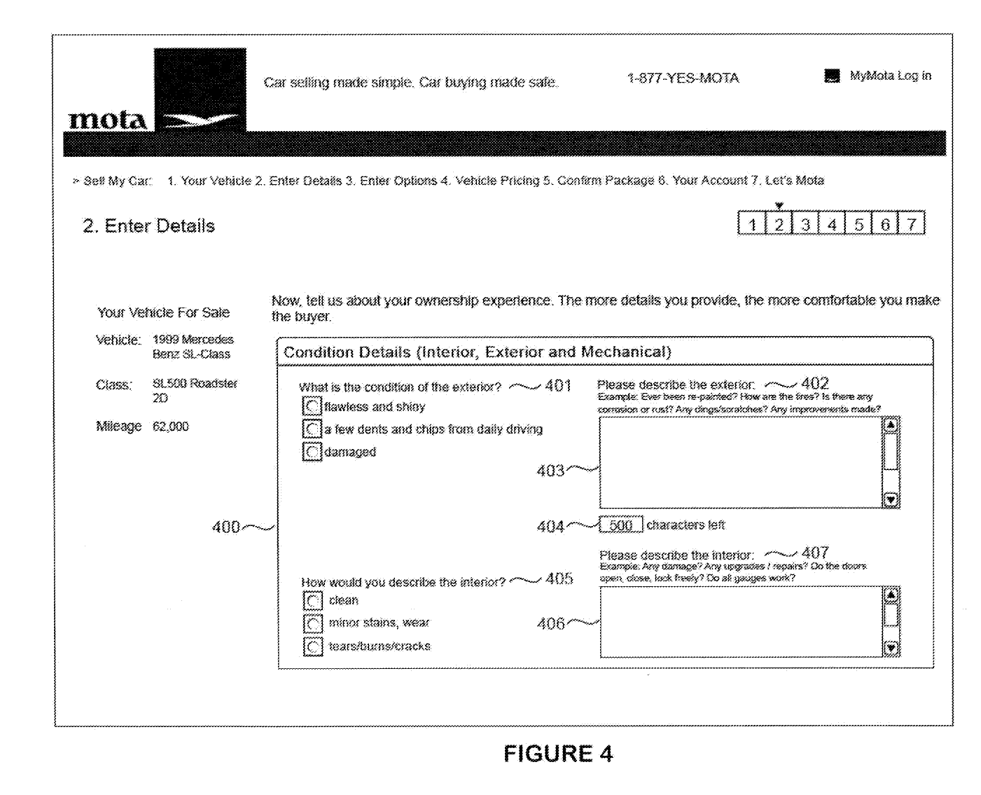

The system provides explanations of the queries and includes a text box where the seller can enter additional information as desired. Referring now to FIG. 4, an example of a query is illustrated. Query 400 relates to the condition of the vehicle exterior and interior. The seller is presented with three checkboxes 401 to generally describe the exterior of the vehicle. The user can simply select one of the boxes and proceed to the next query. Alternatively, the user can enter text into text box 403 to more fully describe the vehicle. This detail supplements (and possibly corrects) the choice of condition 306 selected in step 201.

The system provides helpful hints 402 about items that may be of interest. The seller can simply describe items of the vehicle that match up with the hints above a query box to provide a more useful biography of the vehicle. Alternatively, the seller can choose their own additional description if desired. In one embodiment, the system indicates how many characters the seller can still enter in the text box 404. In one embodiment, the system limits the amount of text the seller can enter as a method of keeping the vehicle biography more readable.

This system of guiding and directing the seller, as well as limiting the number of words, results in a vehicle biography that includes the kind of information that is useful to a buyer and/or in marketing a vehicle. Many times sellers do not know the kind or amount of information to include in a vehicle description, so the system removes the guesswork and uncertainty.

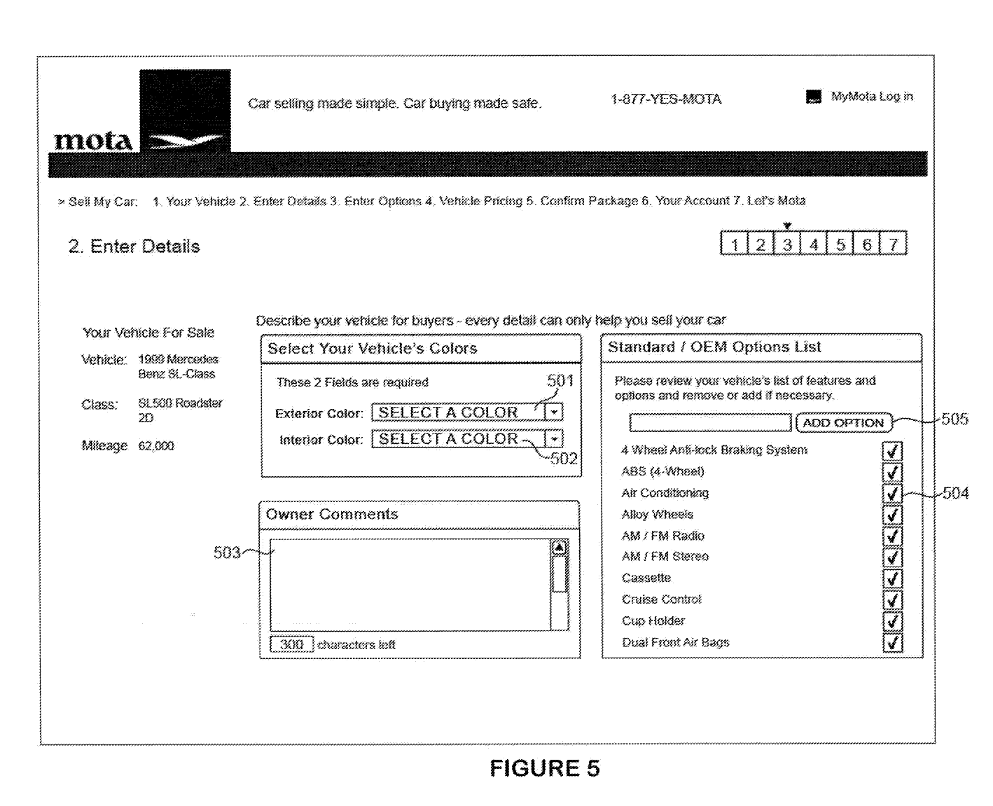

At step 204 the seller is presented with a series of queries that are specific to the year, make and model of the vehicle identified in step 201. Step 204 allows the user to specify certain descriptive features of the vehicle such as interior and exterior color, options, and any additional options or customizations that the vehicle may have. Referring briefly to FIG. 5, the system presents the user with data entry 500 including required fields for exterior color 501 and interior color 502. If the color of the vehicle is not found in available colors of the pull down lists, the user can describe the color in text field 503. Region 504 lists the available options for the year, make, model, and trim level selected by the seller. The seller can de-select any of the options that do not apply and use field 505 to add options that may not be reflected in the list.

Text Analysis

In one embodiment the words from ads for vehicles are collected in a relational database so that the effect of each word on the success of marketing efforts can be determined. The database includes entries for each word and a ranking value for each word in a number of categories, including, but not limited to, frequency of use, average selling price for ads using that word, and average time on the market for ads using that word. Each word can be filtered by make/model/year/options, geographical region, time of year, and related or class of vehicles. The data can be ranked using any of the categories and any of the filters as desired.

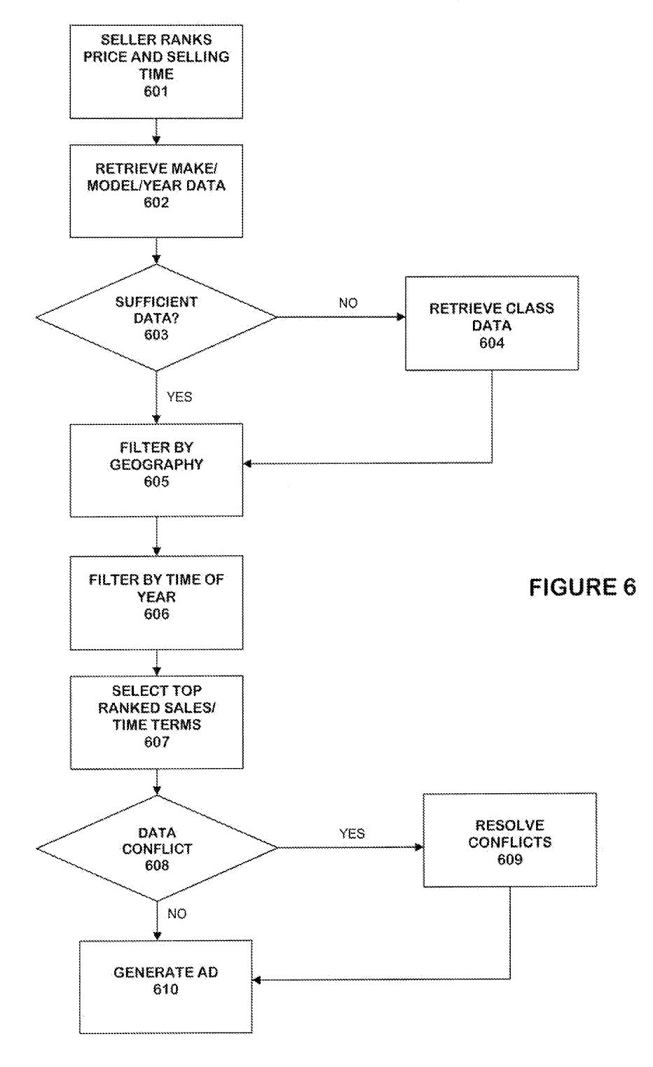

In the system, the user is invited to indicate the importance of price and/or time on the market. In response the system searches the database and finds the highest ranking words for that vehicle in that region for the time of year, and determines the appropriate words that will satisfy the users ranking of price or selling time. FIG. 6 is a flow diagram illustrating the text ranking step of an embodiment of the system. At step 601 the seller is presented with a dialog asking them to rank the importance to the seller of price and time on the market. This could be via a series of selection buttons from “Not Very” to “Very” important with, for example, five gradations. In one embodiment, the two categories are dependent in that if the seller selects, for example, the fourth gradation for selling price, the second gradation for selling time is automatically selected. In another embodiment, the criteria are independent so that the user can select any gradation for either parameter.

At step 602 the system retrieves the make/model/year/options data for the vehicle. At decision block 603 it is determined if there is sufficient database data for that make/model to provide meaningful results. If the sample size is too small, the system retrieves comparable class data at step 604. After step 604, or if there is sufficient data for the make/model, the system proceeds to step 605 and filters the data by geography. It may be that some features or terminology works better in one part of the country than in others. The data can be filtered geographically by zip code, by city, county, region, state, group of states, or whatever geographic area provides useful results.

At step 606 the system filters the data by time of year. This is done after the geographic sort because some terms may have more meaning based on time of year in some regions (e.g. the four season portions of the country) than in others (e.g. the sun belt). A convertible may be harder to sell in the northeast in the winter than in the southwest. Certain features should be played up in cold weather (heater instead of A/C, traction, tires, etc.) that would be downplayed or ignored at other times.

At step 607 the system selects the top ranked sales and selling time terms after the filtering steps At decision block 608 the system determines if there are any conflicts with the terms. For example, certain terms may have a high ranking for short selling time but not for a high price. In one embodiment, the system compares all of the term and if there is a discrepancy of all or a portion of a standard deviation from other terms, a conflict is established. At step 609 the conflicts are resolved using the seller preferences of price and selling time. If the seller has indicated a desire to maximize price, those terms are retained and any terms that are associated with too low of a selling price are eliminated.

After the conflict resolution at step 609, or if there are no conflicts at step 608, the system generates the ad text at step 610.

In an alternate embodiment, the seller may be encouraged to select a selling price of the vehicle as well as a desired time on the market at step 601. The system proceeds as before and would then retrieve at step 607 all terms that match the selling price (or higher) and all terms that match the selling time (or shorter). The conflict check is again performed at step 608 and the system continues with steps 609 and 610 as appropriate.

Text Generation

The system produces text in a number of areas to automatically produce appropriate marketing materials. In one embodiment the text is generated from several sources, including inspection report translation, text generation from user input on vehicle condition, and automated marketing messaging.

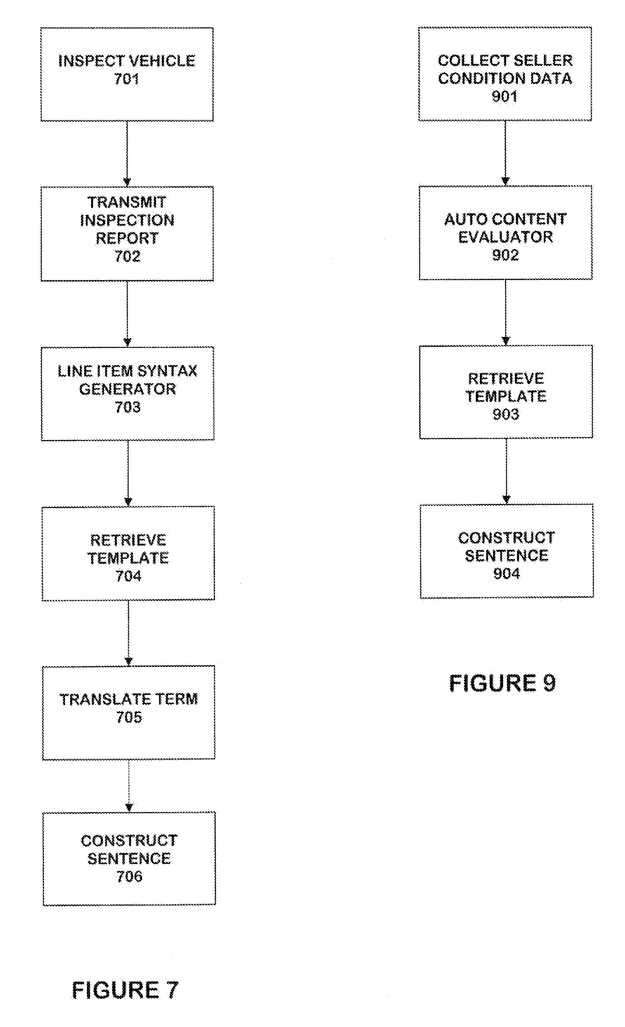

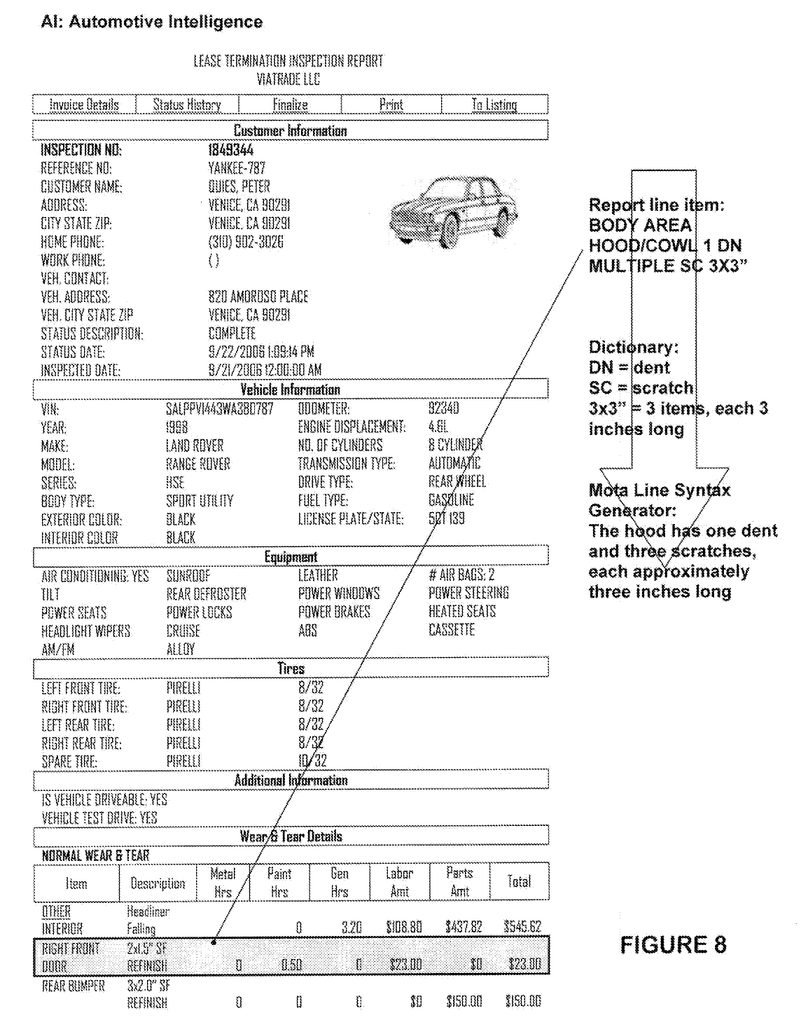

FIGS. 7 and 8 illustrate inspection report translation. At step 701 of FIG. 7, an inspection report is performed. At step 702 the inspection report is provided electronically to the system. Referring briefly to FIG. 8, the inspection report uses a well known shorthand for vehicle condition. To a mechanic, the terms will be understandable, to a consumer they may not. The system translates these terms. At step 703 the system applies a line item syntax generator to translate inspection report terms. At step 704 the system retrieves a template for each line item in the inspection report. For example, the line item highlighted in FIG. 8 at 801 is a body area condition item. The system looks up each shorthand description of line item 801 in a dictionary of terms at step 705. The system then inserts the translation into the template in place of the shorthand description at step 706. Shorthand terms 802 in FIG. 8 translate to dents and scratches in the hood. The constructed sentences of step 706 may appear as sentence 803 of FIG. 8, i.e. “The hood has one dent and three scratches, each approximately three inches long.” This description is more understandable to a consumer and will appear in an accessible area of the marketing materials.

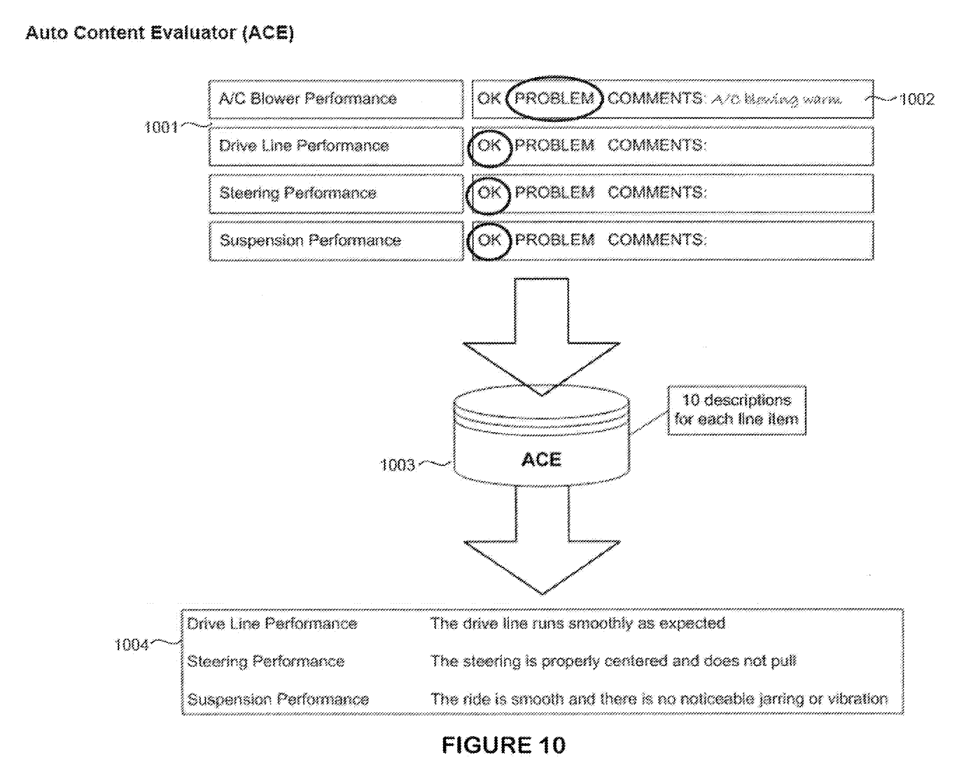

FIGS. 9 and 10 illustrate content generation from vehicle condition information provided by the seller. At step 901 the seller condition data entered in connection with FIGS. 2-5 is collected. FIG. 10 illustrates a subset of this condition data 1001. Region 1001 illustrates certain line items generated from the seller entered data as well as the condition evaluators entered by the seller 1002 and any specific comments. At step 902 the data is processed using an auto content evaluator (ACE) 1003. The ACE 1003 stores a plurality (e.g. ten) descriptions for each line item and selects one of them to use. Each description is a template step 903 that includes blanks that are completed by using data provide by the seller. At step 904 sentences are constructed using the seller data and presented such as sentences in region 1004.

Automated Marketing Messaging

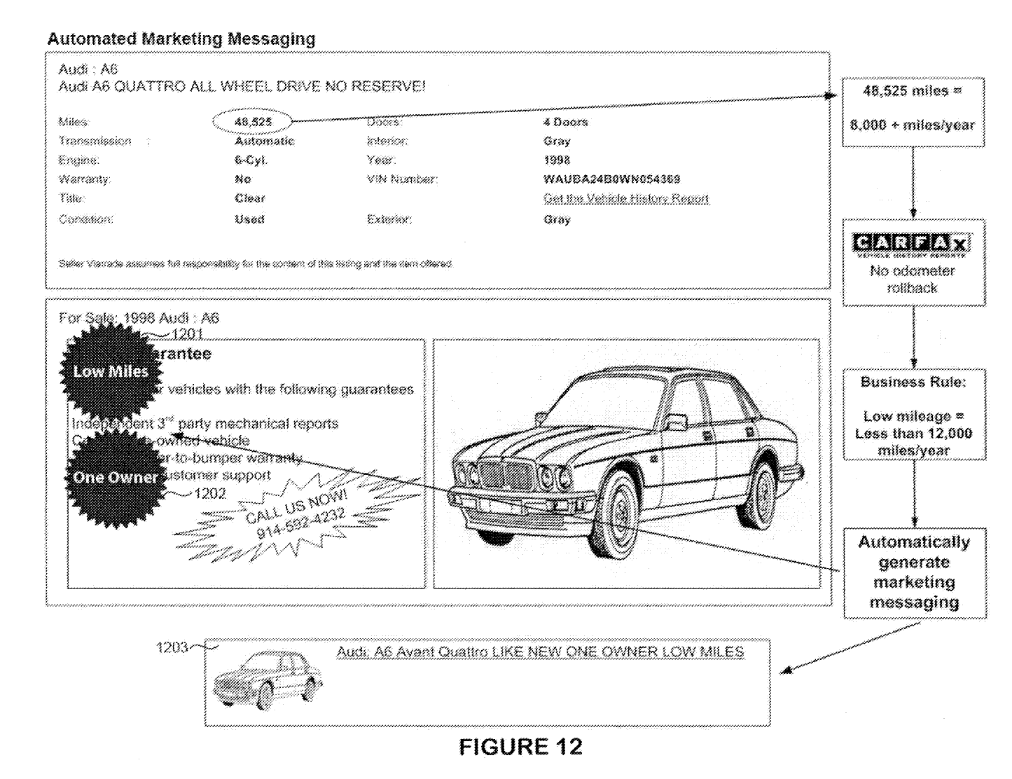

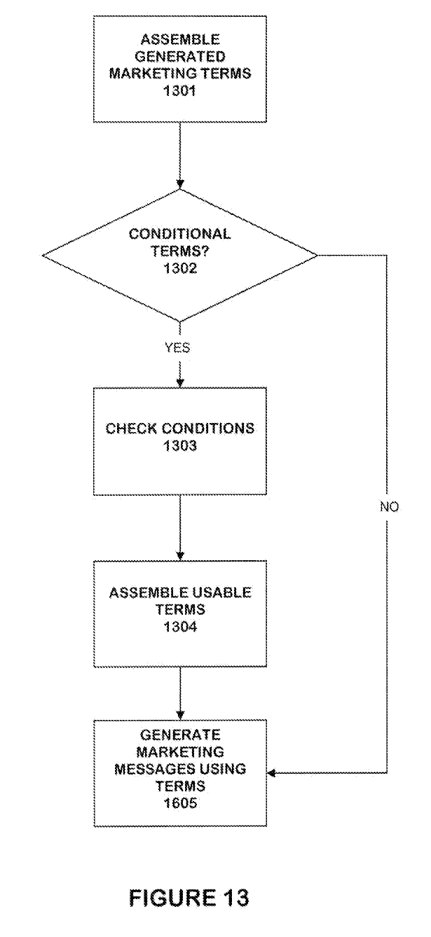

FIGS. 12 and 13 illustrate the automatic marketing messaging of the system. FIG. 13 is a flow diagram illustrating the generation of marketing words and phrases using the text words generated in FIG. 6. FIG. 12 is an example of a marketing approach in one embodiment of the system.

At step 1301 the system collects the text words generated in the operation of FIG. 6. At decision block 1302 the system checks to see if the use of any of the words is conditional. For example, one highly ranked marketing term is “Low Miles”. The system considers that term to be usable only if the car averages less than 12,000 miles per year. This term may also require independent verification such as a vehicle history report (such as CarFax). If there are conditional terms at block 1302, the system proceeds to step 1303 and checks the conditions of the terms. At step 1304 the system passes through the terms that are still usable based on the conditional test.

At step 1305, or if there are no conditional terms at step 1102, the system uses the available text to generate marketing messages. Referring now to FIG. 12, the system may present a marketing page for the vehicle with graphical splash regions 1201 and 1202 using highly ranked terms (in this case “Low Miles” 1201 and “One Owner” 1202). The system also generates additional marketing language such as in region 1203.

Specification Generator

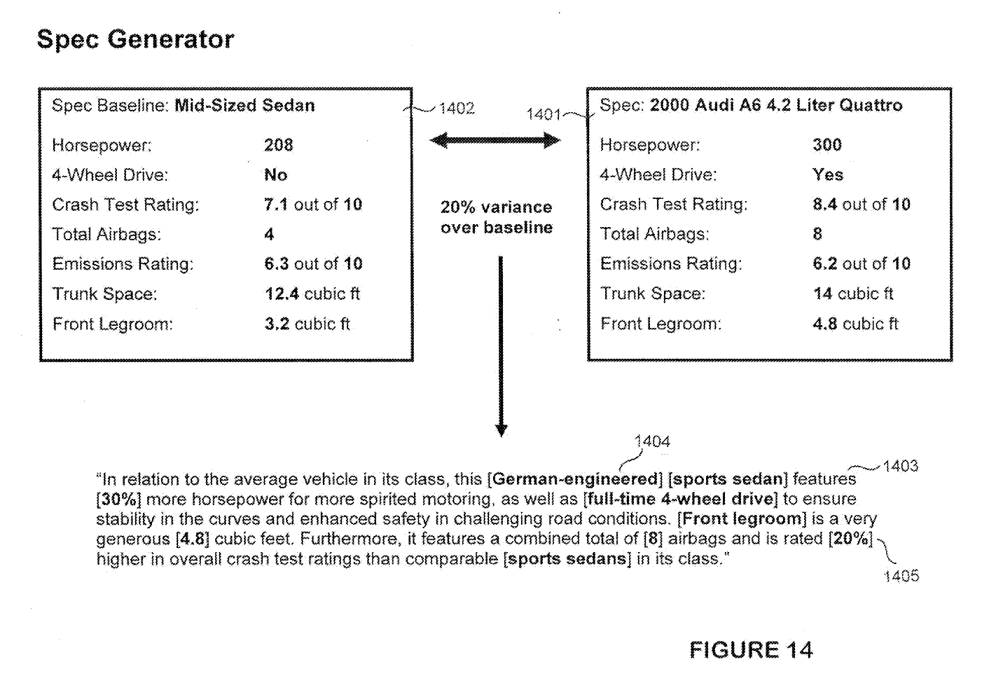

The system can also generate descriptive content based on the specifications of the vehicle and comparison to other vehicles in the class. FIG. 14 illustrates an example of how this is accomplished. The system assembles specification data for the vehicle from available databases. In the region 1401 of FIG. 14, the items selected may be determined by the operation of FIG. 6. There are hundreds of specifications to choose to highlight but the text generator can help in determining which specifications to highlight. The system provides the available data in region 1401. Region 1402 provides average comparison information for the same specifications for an average vehicle in the class.

A textual description of the vehicle specifications is provided in region 1403. The text is generated from a template with areas in bold being variables that are filled in from available vehicle information or are generated by comparison to the baseline parameters. For example, term 1404 is from available information about the example vehicle, namely that it is a German Engineered vehicle. Term 1405 is a comparative value that is generated by comparing crash test ratings of the vehicle and the baseline average.

### Embodiment of Computer Execution Environment (Hardware)

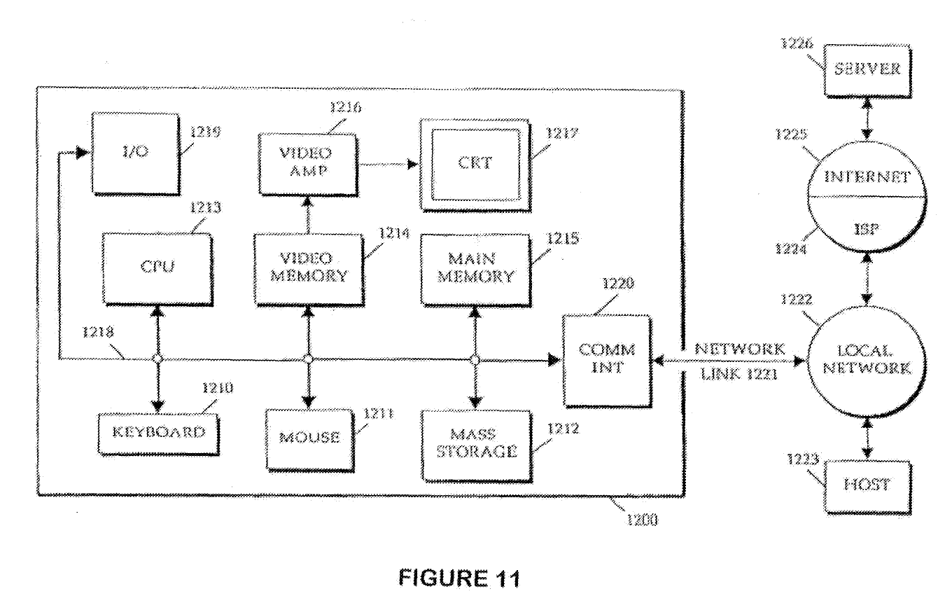

An embodiment of the system can be implemented as computer software in the form of computer readable program code executed in a general purpose computing environment such as environment 1200 illustrated in FIG. 11, or in the form of bytecode class files executable within a Java™ run time environment running in such an environment, or in the form of bytecodes running on a processor (or devices enabled to process bytecodes) existing in a distributed environment (e.g., one or more processors on a network). The system may also be implemented on any suitable computing device such as a PDA, mobile phone, mobile computing device, as a software service hosted on a server, an ethereal network based implementation, or any other suitable processing environment.

In the system of FIG. 11, a keyboard 1210 and mouse 1211 are coupled to a bidirectional system bus 1218. The keyboard and mouse are for introducing user input to the computer system and communicating that user input to central processing unit (CPU) 1213. Other suitable input devices may be used in addition to, or in place of, the mouse 1211 and keyboard 1210. I/O (input/output) unit 1219 coupled to bidirectional system bus 1218 represents such I/O elements as a printer, A/V (audio/video) I/O, etc.

Computer 1200 includes a video memory 1214, main memory 1215 and mass storage 1212, all coupled to bi-directional system bus 1218 along with keyboard 1210, mouse 1211 and CPU 1213. The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as CPU 1213, main memory 1215, video memory 1214 and mass storage 1212. Alternatively, multiplex data/address lines may be used instead of separate data and address lines.

In one or more embodiments of the invention, CPU 1213 is a microprocessor manufactured by IBM, Intel, AMD, Sun Microsystems or any other manufacturer. However, any other suitable microprocessor or microcomputer may be utilized. Main memory 1215 is comprised of dynamic random access memory (DRAM).

Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1200 may also include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to host computer 1223 or to data equipment operated by an Internet Service Provider (ISP) 1224. ISP 1224 in turn provides data communication services through the world wide packet data communication network now commonly referred to as the “Internet” 1225. Local network 1222 and Internet 1225 both use electrical, electromagnetic or optical signals which carry digital data streams. The signals through the various networks and the signals on network link 1221 and through communication interface 1220, which carry the digital data to and from computer 1200, are exemplary forms of carrier waves transporting the information.

Computer 1200 can send messages and receive data, including program code, through the network(s), network link 1221, and communication interface 1220. In the Internet example, server 1226 might transmit a requested code for an application program through Internet 1225, ISP 1224, local network 1222 and communication interface 1220. In accord with the invention, one such downloaded application is the method and apparatus for creating, editing and displaying works containing time-dimensioned textual components described herein.

The received code may be executed by CPU 1213 as it is received, and/or stored in mass storage 1212, or other non-volatile storage for later execution. In this manner, computer 1200 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the system may be implemented in any type of computer system or programming or processing environment.

Thus, a method and apparatus for automatic marketing is provided.

What is claimed is:

1. A method for generating marketing content for an item comprising:
generating a database of terms used in marketing of the item;
ranking the terms based on certain parameters and generating ranked terms;
automatically selecting ranked terms for marketing based on the ranking.

2. The method of claim 1 wherein the certain parameters comprise selling price and time on the market.

3. The method of claim 2 further including the step of filtering the database of ranked terms based on geographic area.

4. The method of claim 3 further including the step of filtering the database of ranked terms based on time of year.

5. The method of claim 1 wherein at least one of the ranked terms is a conditional term.

6. The method of claim 5 further including the step of determining if the conditional term may be used by determining if a condition associated with the conditional term is satisfied.

7. The method of claim 4 further including the steps of:
selecting a plurality of item specifications of the item;
selecting a plurality of baseline specifications for a similar item;
automatically generating a comparison of the item specifications and baseline specifications.

8. The method of claim 4 further including the step of a seller of the item identifying a preference for one of selling price and time on the market.

9. The method of claim 8 further including the step of ranking the terms based on the preference.

10. The method of claim 9 further including the step of collecting seller generated data on the item and automatically generating marketing content based on the seller generated data.
